(19) United States
(12) Patent Application Publication
(10) Pub. No.: US 2026/0079459 A1
(43) Pub. Date: Mar. 19, 2026

(54) VEHICLE RESTRAINT SIMULATION

(71) Applicant: Ford Global Technologies, LLC, Dearborn, MI (US)

(72) Inventors: Adam Merz, New Boston, MI (US); Steve Nowitzke, Dearborn, MI (US)

(73) Assignee: Ford Global Technologies, LLC, Dearborn, MI (US)

(21) Appl. No.: 18/885,845

(22) Filed: Sep. 16, 2024

(51) Int. Cl. G05B 17/02

(52) U.S. Cl. CPC G05B 17/02

(57) ABSTRACT

A device is provided between the restraint control module and the main body wire harness. The device is connected to the restraint control module and to the main body wire harness. Via the device, actuation of a vehicle restraint device is simulated based on data indicating a vehicle impact.

Vehicles typically include restraint devices. A restraint device may, for example, be a three-point harness for a seat. The three-point harness may include an anchor, a retractor, a pretensioner, and a buckle. The anchor attaches one end of the webbing to a frame of the seat. The other end of the webbing feeds into the retractor, which may include a spool that extends and retracts the webbing. A clip slides freely along the webbing and, when engaged with the buckle, divides the webbing into a lap band and a shoulder band. The pretensioner may be engaged with the retractor to remove slack in the webbing during an impact.

As another example, the restraint device may be an airbag. An inflator activates and provides inflation medium to the airbag, and the airbag pressurizes and acts as supplemental restraints for occupants during an impact. The airbag can be located at various fixed positions in passenger cabins of vehicles. As examples, vehicles may include a driver airbag mounted in the steering wheel, a passenger airbag mounted in the top of a dash in a vehicle-forward direction from the front passenger seat, and side curtain airbags mounted in the frame above the doors.

### BRIEF DESCRIPTION OF THE DRAWINGS

FIG. 1 is a block diagram of an example vehicle control system.

FIGS. 2A-2B are block diagrams of example restraint simulation systems.

FIG. 3 is a flowchart of an example process for simulating actuation of a restraint device in a vehicle.

### DESCRIPTION

Vehicles may include assist features that are activated in response to certain vehicle impacts. An assist feature is an operation in a vehicle to actuate one or more vehicle components based on data from vehicle sensors and/or components indicating a vehicle impact. Non-limiting examples of assist features include fuel disablement features, first-responder communication features, location broadcast features, post-impact braking features, etc. Vehicle impacts can be simulated to verify activation of one or more assist features.

However, preventing activation of restraint devices during the simulated vehicle impact requires significant time and manpower to prepare the vehicle for the simulated impact. A deviation in a preparation procedure can result in activation of one or more restraint devices during the simulated vehicle impact.

As disclosed herein, a device includes a computer that is programmed to simulate activation of vehicle restraint devices based on data indicating a vehicle impact. The device is connected to a restraint control module (RCM) and a main body wire harness of the vehicle such that the device is arranged between the RCM and the restraint devices. The device permits simulation of the vehicle impact while preventing the activation of the restraint devices, which increases a likelihood of non-destructive (i.e., no activation of the restraint devices) simulation of the vehicle impact. Further, connecting the device to the RCM and the main body harness between the RCM and the restraint devices can reduce an amount of time and manpower for preparing the vehicle for the simulated impact.

A device includes a restraint simulator configured to simulate actuation of a vehicle restraint device based on data indicating a vehicle impact. The device further includes a first connector configured to communicatively connect the restraint simulator to a restraint control module. The device further includes a second connector configured to communicatively connect the restraint simulator to the vehicle restraint device via a main body wire harness.

The device can further include a ground wire configured to connect to the restraint control module and to a vehicle body.

The restraint simulator can be further configured to prevent actuation of the vehicle restraint device.

The vehicle restraint device can be one of an airbag, a pretensioner, and a retractor.

The restraint simulator can be one of a computer or a resistor.

A method includes providing a device between the restraint control module and a main body wire harness. The method further includes connecting the device to the restraint control module and to the main body wire harness. The method further includes simulating, via the device, actuation of a vehicle restraint device based on data indicating a vehicle impact.

The method can further include disconnecting the restraint control module from a vehicle body.

The method can further include connecting a ground wire of the device to the restraint control module and to the vehicle body.

The vehicle restraint device can be communicatively connected to the device via the main body wire harness.

The method can further include actuating, via a vehicle computer, an assist feature based on the data indicating the vehicle impact.

The method can further include receiving, from a remote computer, the data indicating the vehicle impact.

The data indicating the vehicle impact can be simulated data.

The vehicle restraint device can be one of an airbag, a pretensioner, and a retractor.

The method can further include preventing, via the device, actuation of the vehicle restraint device.

A system includes a vehicle computer including a first processor and a first memory, the first memory storing instructions executable by the first processor such that the vehicle computer is programmed to actuate an assist feature based on data indicating a vehicle impact. The system further includes a restraint control module. The system further includes a vehicle restraint device. The system further includes a device communicatively connected to the restraint control module and communicatively connected, via a main body wire harness, to the vehicle restraint device. The device includes a restraint simulator configured to simulate actuation of vehicle restraint devices based on the data indicating the vehicle impact.

The data indicating the vehicle impact can be simulated data.

The device can further include a ground wire configured to connect to the restraint control module and to a vehicle body.

The restraint simulator can be further configured to prevent actuation of the vehicle restraint device.

The vehicle restraint device can be one of an airbag, a pretensioner, and a retractor.

The restraint simulator is one of a computer or a resistor.

Further disclosed herein is a computing device programmed to execute any of the above method steps. Yet further disclosed herein is a computer program product, including a computer readable medium storing instructions executable by a computer processor, to execute an of the above method steps.

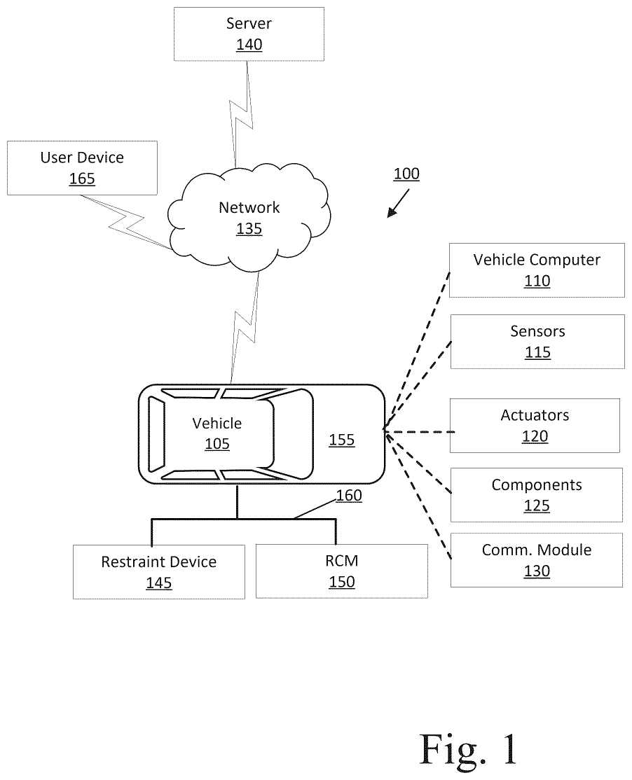

With reference to FIG. 1, an example vehicle control system 100 includes a vehicle 105. The vehicle 105 may be any type of vehicle 105 with two or more wheels (e.g., a motorcycle or motorbike, passenger or commercial automobile such as a sedan, a coupe, a truck, a sport utility, a crossover, a van, a minivan, a taxi, a bus, etc.). A vehicle computer 110 in the vehicle 105 receives data from sensors 115.

The vehicle 105 includes the vehicle computer 110, the sensors 115, actuators 120 to actuate various vehicle components 125, and a vehicle communications module 130. The communications module 130 allows the vehicle computer 110 to communicate with a remote server computer 140, and/or other vehicles (e.g., via a messaging or broadcast protocol such as Dedicated Short Range Communications (DSRC), cellular, and/or other protocol that can support vehicle-to-vehicle, vehicle-to infrastructure, vehicle-to-cloud communications, or the like, and/or via a packet network 135).

The vehicle computer 110 includes a processor and a memory. The memory includes one or more forms of computer-readable media, and stores instructions executable by the vehicle computer 110 for performing various operations, including as disclosed herein. The vehicle computer 110 can further include two or more computing devices operating in concert to carry out vehicle 105 operations including as described herein. Further, the vehicle computer 110 can be a generic computer with a processor and memory as described above, and/or may include an electronic control unit (ECU) or electronic controller or the like for a specific function or set of functions, and/or may include a dedicated electronic circuit including an ASIC that is manufactured for a particular operation (e.g., an ASIC for processing sensor data and/or communicating the sensor data). In another example, the vehicle computer 110 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, (e.g., stored in a memory electrically connected to the FPGA circuit). In some examples, a combination of processor(s), ASIC(s), and/or FPGA circuits may be included in the vehicle computer 110.

The vehicle computer 110 may operate and/or monitor the vehicle 105 including controlling and/or monitoring components 125. The vehicle computer 110 may include programming to operate one or more of vehicle propulsion, steering, transmission, climate control, interior and/or exterior lights, horn, doors, etc., as well as to determine whether and when the vehicle computer 110, as opposed to a human operator, is to control such operations. Additionally, the computer may be programmed to determine whether and when a human operator is to control such operations.

The vehicle computer 110 may include or be communicatively coupled to (e.g., via a vehicle communications network such as a communications bus as described further below), more than one processor (e.g., included in electronic controller units (ECUs) or the like) included in the vehicle 105 for monitoring and/or controlling various vehicle components 125 (e.g., a transmission controller, a steering controller, etc.). The vehicle computer 110 is generally arranged for communications on a vehicle communication network that can include a bus in the vehicle 105 such as a controller area network (CAN) or the like, and/or other wired and/or wireless mechanisms.

Via the vehicle 105 network, the vehicle computer 110 may transmit messages to various devices in the vehicle 105 and/or receive messages (e.g., CAN messages) from the various devices (e.g., sensors 115, an actuator 120, ECUs, etc.). Alternatively, or additionally, in cases where the vehicle computer 110 actually comprises a plurality of devices, the vehicle communication network may be used for communications between devices represented as the vehicle computer 110 in this disclosure. Further, as mentioned below, various controllers and/or sensors 115 may provide data to the vehicle computer 110 via the vehicle communication network.

Vehicle 105 sensors 115 may include a variety of devices such as are known to provide analog and/or digital data measuring or describing physical phenomena. “Data” herein means information that can be processed and/or stored by a digital computer. Data can be provided and/or represented in a variety of formats (e.g., binary, hexadecimal, alphanumeric, e.g., ASCII, etc.). A sensor herein means a device that can obtain data including one or more measurements of one or more physical phenomena. Vehicle sensors 115 could include cameras, lidar, radar, ultrasonic sensors, and various other sensors, including as described by way of example as follows. Some vehicle sensors 115 detect internal states of the vehicle 105, for example, wheel speed, wheel orientation, and engine and transmission variables. Some vehicle sensors 115 detect the position or orientation of the vehicle 105, for example, global positioning system GPS sensors; accelerometers such as piezo-electric or microelectromechanical systems MEMS; gyroscopes such as rate, ring laser, or fiber-optic gyroscopes; inertial measurements units IMU; and magnetometers. Some sensors 115 detect the external world, for example, radar sensors, scanning laser range finders, light detection and ranging LIDAR devices, and image processing sensors such as cameras. A LIDAR device detects distances to objects by emitting laser pulses and measuring the time of flight for the pulse to travel to the object and back. In the context of this disclosure, an object is a physical (i.e., material) item that has mass and that can be represented by physical phenomena (e.g., light or other electromagnetic waves, or sound, etc.) detectable by sensors 115. Thus, the vehicle 105, as well as other items including as discussed below, fall within the definition of “object”herein.

Some sensors 115 are communications devices, for example, vehicle-to-infrastructure (V2I) or vehicle-to-vehicle (V2V) devices. Sensor operation can be affected by obstructions (e.g., dust, snow, insects, etc.). Often, but not necessarily, a sensor 115 includes a digital-to-analog converter to converted sensed analog data to a digital signal that can be provided to a digital computer (e.g., via a network). Sensors 115 can include a variety of devices, and can be disposed to sense an environment, provide data about a machine, etc., in a variety of ways. For example, the sensors 115 can be mounted to any suitable location in or on the vehicle 105 to collect image data of the environment around the vehicle 105. Image data herein means digital image data (e.g., comprising pixels with intensity and color values) that can be acquired by camera sensors 115.

Moreover, various controllers in a vehicle 105 may operate as vehicle sensors 115 to provide data via the vehicle network or bus (e.g., data relating to vehicle 105 speed, location, subsystem and/or component 125 status, etc.). Further, other sensors 115 could include cameras, short range radar, long range radar, LIDAR, and/or ultrasonic transducers, weight sensors, accelerometers, motion detectors, etc. (i.e., sensors to provide a variety of data). The vehicle computer 110 is programmed to receive data from one or more sensors 115 substantially continuously, periodically, and/or when instructed by a remote server computer 140, etc. To provide just a few non-limiting examples, sensor data could include data for determining a position of a component 125, a location of an object, a speed of an object, a type of an object, a slope of a roadway or surface of an area, a temperature, a presence or amount of moisture, a data rate, etc. Location data specifies a point or points on a ground surface and may be in a known form (e.g., geo-coordinates such as latitude and longitude coordinates obtained via a navigation system, as is known, that uses the Global Positioning System (GPS)).

The vehicle 105 actuators 120 are implemented via circuits, chips, or other electronic and/or mechanical components that can actuate various vehicle subsystems in accordance with appropriate control signals as is known. The actuators 120 may be used to control components 125 to operate a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a suspension component (e.g., that may include one or more of a damper (e.g., a shock or a strut), a bushing, a spring, a control arm, a ball joint, a linkage, etc.), a park assist component, an adaptive cruise control component, an adaptive steering component, etc.

The vehicle 105 further includes one or more restraint devices 145 (e.g., arranged in a passenger cabin of the vehicle 105) and that can operate to restrain or constrain movement of a vehicle occupant, e.g., upon certain impacts to the vehicle. A restraint device 145 may be connected to a vehicle body 155 or another vehicle component 125. The restraint devices 145 are configured to control kinematics of occupants during vehicle impacts. The restraint devices 145 can be any suitable type of device (e.g., a retractor, a pretensioner, an airbag, etc.).

The vehicle 105 further includes control modules, e.g., ECUs or the like, programmed for performing different functions for the vehicle 105. Specifically, the vehicle 105 includes a restraint control module (RCM) 150 programmed to actuate one or more restraint devices 145 in response to detecting certain vehicle impacts (e.g., based on sensor 115 data). The RCM 150 may be connected to the vehicle body 155 (e.g., via clips, screws, bolts, etc.) The vehicle 105 may any suitable number of control modules. Other non-limiting examples of control modules include an engine control module, a body control module, an accessory control module, a power-steering control module, an antilock brake control module, etc.

The vehicle 105 further includes a main body wire harness 160. The main body wire harness 160 is arranged in the passenger cabin of the vehicle 105. The main body wire harness 160 is positioned to supply electricity to one or more devices (e.g., control modules such as the RCM 150, sensors 115, actuators 120, vehicle components 125, restraint devices 145, etc.) within the passenger cabin and/or the vehicle computer 110. The main body wire harness 160 further communicatively connects the devices (e.g., control modules, sensors 115, actuators 120, vehicle components 125, restraint devices, etc.) and/or the vehicle computer 110 to each other. That is, main body wire harness 160 may provide a wired connection between the vehicle computer 110 and/or various devices within the passenger cabin to facilitate communication via the vehicle network.

The vehicle computer 110 may further be configured for communicating via a vehicle-to-vehicle communication module 130 or interface with devices outside of the vehicle 105 (e.g., through a vehicle-to-vehicle (V2V) or vehicle-to-infrastructure (V2X) wireless communications (cellular and/or short-range radio communications, etc.)) to another vehicle, and/or to a remote server computer 140 (typically via direct radio frequency communications). The communications module 130 could include one or more mechanisms, such as a transceiver, by which the computers of vehicles may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module 130 include cellular, Bluetooth, IEEE 802.11, dedicated short range communications (DSRC), cellular V2X (CV2X), and/or wide area networks (WAN), including the Internet, providing data communication services. The label “V2X” is used herein for communications that may be vehicle-to-vehicle (V2V) and/or vehicle-to-infrastructure (V2I), and that may be provided by communication module 130 according to any suitable short-range communications mechanism (e.g., DSRC, cellular, or the like).

The network 135 represents one or more mechanisms by which a vehicle computer 110 may communicate with remote computing devices (e.g., the remote server computer 140, another vehicle computer, a user device 165, etc.). Accordingly, the network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

The remote server computer 140 can be a conventional computing device (i.e., including one or more processors and one or more memories) programmed to provide operations such as disclosed herein. Further, the remote server computer 140 can be accessed via the network 135 (e.g., the Internet, a cellular network, and/or or some other wide area network).

The user device 165 can be a conventional computing device (i.e., including one or more processors and one or more memories) programmed to provide operations such as disclosed herein. The user device 165 can be a portable device. A portable device can be any one of a variety of computers that can be used while carried by a person (e.g., a smartphone, a tablet, a personal digital assistant, a smart watch, a key fob, etc.). Further, the user device 165 can be accessed via the network 135 (e.g., the Internet, a cellular network, and/or or some other wide area network).

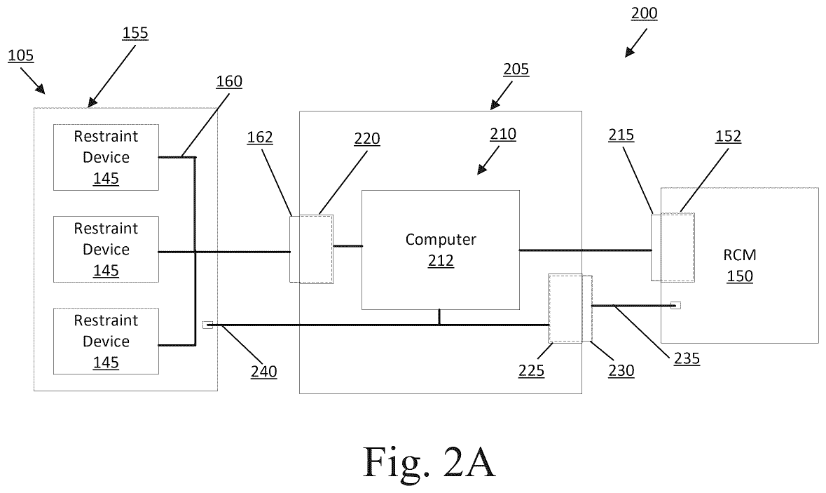

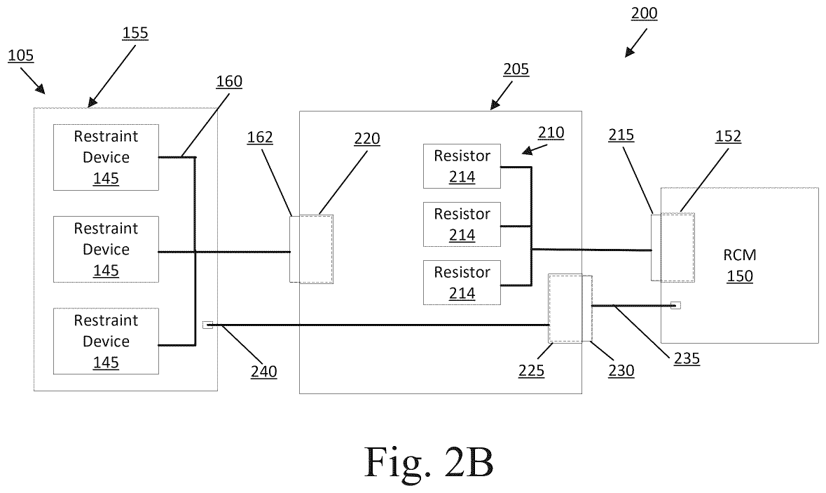

Turning now to FIG. 2, an example restraint simulation system 200 includes the vehicle 105 (e.g., the restraint devices 145, the RCM 150, and the vehicle body 155) and a device 205. The device 205 is selectively connectable to the RCM 150 and the main body wire harness 160. For example, the device 205 may be connected to the RCM 150 and the main body wire harness 160. The device 205 includes a restraint simulator 210, a first connector 215, and a second connector 220.

The restraint simulator 210 may, for example, be a computer 212 (as shown in FIG. 2A). The computer 212 can be a conventional computing device (i.e., including one or more processors and one or more memories) programmed to provide operations such as disclosed herein. Further, the computer 212 can be accessed via the network 135 (e.g., the Internet, a cellular network, and/or or some other wide area network).

As another example, the restraint simulator 210 may be one or more resistors 214. The restraint simulator 210 may include respective resistors 214 for each respective restraint device 145. The resistors 214 may be designed to create a voltage drop that simulates actuation of the respective restraint device 145. For example, the RCM 150 can output a voltage to the respective resistor 214 and can receive a voltage from the resistor 214 that indicates actuation of the corresponding restraint device 145. The resistors 214 prevent the output voltage from reaching the restraint devices 145.

The first connector 215 is configured to communicatively connect the restraint simulator 210 to the RCM 150. That is, the first connector 215 may be designed to mate with a connector 152 of the RCM 150. For example, the first connector 215 may be a quick disconnect electrical connector (e.g., as currently used in automotive applications) designed to be received by a quick disconnect electrical connector 152 of the RCM 150. That is, the first connector 215 may be substantially identical to a connector 162 of the main body wire harness 160. Upon connecting the first connector 215 to the RCM 150, the restraint simulator 210 can communicate with the RCM 150 (e.g., via the vehicle network).

The second connector 220 is configured to communicatively connect the device 205 to the restraint devices 145. That is, the second connector 220 may be designed to mate with the connector 162 of the main body wire harness 160. For example, the second connector 220 may be a quick disconnect electrical connector designed to receive a quick disconnect electrical connector 162 of the main body wire harness 160. That is, the second connector 220 may be substantially identical to the connector 152 of the RCM 150. Upon connecting the second connector 220 to the main body wire harness 160, the device 205 can communicate with the restraint devices 145 (e.g., via the vehicle network). As one example, the second connector 220 may communicatively connect the computer 212 to the restraint devices 145 (as shown in FIG. 2A).

The device 205 may further include a third connector 225. The third connector 225 may be configured to electrically ground the RCM 150. For example, the third connector 225 may be designed to mate to a connector 230 of a ground wire 235. The ground wire may further be connectable (e.g., via a screw or the like) to a housing of the RCM 150. The third connector 225 may be a quick disconnect electrical connector designed to receive a quick disconnect electrical connector 230 of the ground wire. The third connector 225 may further be connected to a second ground wire 240 that is connectable (e.g., via a screw or the like) to the vehicle body 155. That is, the RCM 150 can be grounded to the vehicle body 155 by connecting the second ground wire 240 to the vehicle body 155 and connecting the ground wire 235 to the third connector 225 (e.g., via the connector 230) and the housing of the RCM 150.

The vehicle computer 110 can be programmed to actuate an assist feature based on data indicating a vehicle impact. That is, in response to receiving data indicating a vehicle impact, the vehicle computer 110 actuate location broadcast features, post-impact braking features, etc. The vehicle computer 110 can receive (e.g., via the network 135) the data indicating the vehicle impact from the user device 165 or another remote computer (e.g., the remote server computer 140). The vehicle computer 110 can identify assist features to actuate based on the received data. For example, the vehicle computer 110 can access a database, or the like, that associates one or more assist features with various vehicle impact data. The database may be stored (e.g., in a memory of the vehicle computer 110).

The vehicle computer 110 may, for example, provide the data indicating the vehicle impact to the RCM 150 (e.g., via the vehicle network). As another example, the RCM 150 may receive the data indicating the vehicle impact from the remote computer 140, 165 (e.g., via the network 135).

The remote computer 140, 165 can, for example, determine the data indicating the vehicle impact based on a user input. For example, the remote computer 140, 165 may include a human-machine interface that can detect a user input (e.g., via sensors on a touch screen) specifying a type of vehicle impact (e.g., front impact, side impact, oblique impact, etc.) The remote computer 140, 165 may store (e.g., in a memory thereof) a database, or the like, that associates various data with various types of vehicle impacts. Upon detecting the user input, the remote computer 140, 165 can access the database to select the data indicating the vehicle impact that corresponds to the specified vehicle impact. The remote computer 140, 165 can then transmit the selected data indicating the vehicle impact to the vehicle computer 110 and/or the RCM 150 (e.g., via the network 135).

The data indicating the vehicle impact may be simulated data. For example, the data may be specified (e.g., via a user input) to include sensor 115 data that represents a simulated vehicle impact (e.g., the data is outside of respective operating ranges for respective sensors 115). As another example, the data indicating the vehicle impact may be collected during a simulated impact of a virtual vehicle (e.g., via a vehicle dynamics model (i.e., a physics-based kinematic or dynamic model describing vehicle motion)). As yet another example, the data indicating the vehicle impact may be collected during a physical vehicle impact simulation (e.g., as currently performed in automotive applications).

The RCM 150 is programmed to identify restraint devices 145 for actuation based on the data indicating the vehicle impact. For example, the RCM 150 can access a database, or the like, that associates restraint devices 145 to be actuated with vehicle impact data and/or types of vehicle impacts. The database may be stored (e.g., in a memory of the RCM 150). Upon identifying the one or more restraint devices 145 for actuation, the RCM 150 can transmit (e.g., via the vehicle network) instructions or a voltage to actuate the identified restraint devices 145.

When the device 205 is connected to the RCM 150, the instructions to actuate the identified restraint devices 145 are provided to the restraint simulator 210. The restraint simulator 210 simulates operation of the identified restraint devices 145. For example, the computer 212 can access a database, or the like, that associates various identified restraint devices 145 with respective resistance values. The respective resistance value is a numerical value indicating an amount of resistance measured in response to activation of a respective restraint device 145. The respective resistance values may be specified by a manufacturer of the respective restraint devices 145. The database may be stored (e.g., in a memory of the computer 212).

The computer 212 can determine the identified restraint devices 145 based on the received instructions and can then determine respective resistance values associated with the identified restraint devices 145 via the database. The computer 212 can simulate the actuation of the identified restraint devices 145 by providing the respective resistance values to the RCM 150 (e.g., via the vehicle network). The computer 212 further can prevent actuation of the identified restraint devices 145. For example, the computer 212 can block transmission of the instructions to the main body wire harness 160 (e.g., via resistors placed between the computer 212 and the second connector 220 configured to prevent the instructions from being output from the device 205). Upon receiving the respective resistance values, the RCM 150 can determine that the identified restraint devices 145 are actuated despite the device 205 preventing actuation of the identified restraint devices 145. That is, the device 205 permits actuation of one or more assist features by simulating actuation of the restraint devices 145.

As another example, the resistors 214 can receive the voltage from the RCM 150 and can output the respective resistance values to the RCM 150 (e.g., via the vehicle network). In such an example, the resistors 214 can prevent the voltage from reaching the restraint devices 145 so as to prevent actuation of the identified restraint devices 145.

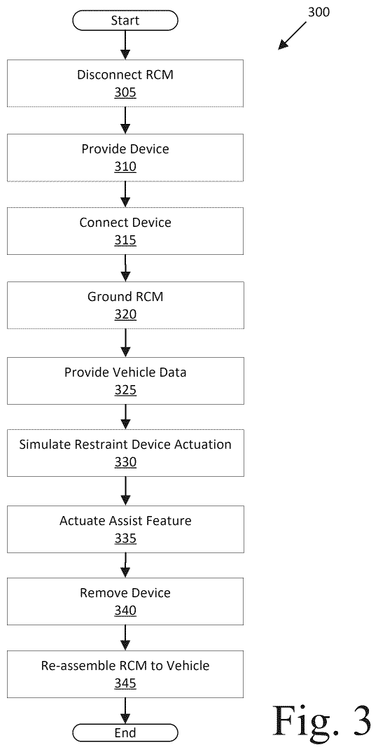

FIG. 3 is a flow chart illustrating an exemplary process 300 for simulating operation of a restraint device in a vehicle 105. The process 300 begins in a block 305. The process 300 can be carried out by a user utilizing a vehicle computer 110 executing program instructions stored in a memory thereof and a restraint simulator 210 included in a device 205.

In the block 305, an RCM 150 is disconnected from a main body wire harness 160 of the vehicle 105. For example, the user can remove carpet and/or trim panels connected to a vehicle body 155 to access the RCM 150. The user can then disconnect a connector 162 of the main body harness 160 from a connector 152 of the RCM 150. Additionally, the user can disconnect a housing of the RCM 150 from the vehicle body 155. The process 300 continues in a block 310.

In the block 310, a device 205 is provided to simulate operation of one or more restraint devices 145 in the vehicle 105. The user may, for example, obtain the device 205 and arrange the device 205 between the RCM 150 and the main body wire harness 160. The process 300 continues in a block 315.

In the block 315, the device 205 is connected to the RCM 150 and the main body wire harness 160. For example, the user can connect a first connector 215 of the device 205 to the connector 152 of the RCM 150 and can connect a second connector 220 of the device 205 to the connector 162 of the main body wire harness 160. The process 300 continues in a block 320.

In the block 320, the user grounds the RCM 150. For example, the user can connect a ground wire 235 to a housing of the RCM 150. The user can then connect a connector 230 of the ground wire to a third connector 225 of the device 205. Additionally, the user can connect a second ground wire 240 to the vehicle body 155. The second ground wire 240 is connected to the third connector 225, as discussed above. The process 300 continues in a block 325.

In the block 325, data indicating a vehicle impact is provided to the RCM 150. For example, the user can specify the data indicating the vehicle impact via a user input to a remote computer 140, 165, as discussed above. The remote computer 140, 165 can then transmit (e.g., via the network 135) the specified data to the vehicle computer 110, which can then provide the data to the RCM 150 (e.g., via the vehicle network). Alternatively, the remote computer 140, 165 can transmit (e.g., via the network 135) the specified data to the RCM 150. The process 300 continues in a block 330.

In the block 330, the device 205 simulates actuation of one or more restraint devices 145. For example, the RCM 150 can identify one or more restraint devices 145 for actuation based on the data indicating the vehicle impact, as discussed above. The RCM 150 can then initiate a restraint simulator 210 in the device 205 to simulate actuation of the identified restraint device(s) 145. The restraint simulator 210 prevents transmission (e.g., of instructions or voltages) to the main body wire harness 160 and provides respective resistance values to the RCM 150, as discussed above. The process 300 continues in a block 335.

In the block 335, the vehicle computer 110 actuates one or more assist features based on the data indicating the vehicle impact, as discussed above. The process 300 continues in a block 340.

In the block 340, the device 205 is removed from the vehicle 105. For example, the user may disconnect the device 205 (e.g., the first, second and third connectors 215, 220, 225 and the second ground wire 240) from the RCM 150, the main body wire harness 160, and the vehicle body 155. Further, the user may disconnect the ground wire 235 from the RCM 150. The process 300 continues in a block 345.

In the block 345, the RCM 150 is connected to the main body wire harness 160. For example, the user can connect the connector 162 of the main body wire harness to the connector 152 of the RCM 150. Further, the user can connect the housing of the RCM 150 to the vehicle body 155. Additionally, the user can re-assemble the carpet and/or trim panels to cover the RCM 150. The process 300 ends following the block 345.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board first computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions (e.g., from a memory, a computer readable medium, etc.) and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A device, comprising:
a restraint simulator configured to simulate actuation of a vehicle restraint device based on data indicating a vehicle impact;
a first connector configured to communicatively connect the restraint simulator to a restraint control module; and
a second connector configured to communicatively connect the restraint simulator to the vehicle restraint device via a main body wire harness.

2. The device of claim 1, further comprising a ground wire configured to connect to the restraint control module and to a vehicle body.

3. The device of claim 1, wherein the restraint simulator is further configured to prevent actuation of the vehicle restraint device.

4. The device of claim 1, wherein the vehicle restraint device is one of an airbag, a pretensioner, and a retractor.

5. The device of claim 1, wherein the restraint simulator is one of a computer or a resistor.

6. A method, comprising:
providing a device between the restraint control module and a main body wire harness;
connecting the device to the restraint control module and to the main body wire harness; and
simulating, via the device, actuation of a vehicle restraint device based on data indicating a vehicle impact.

7. The method of claim 6, further comprising disconnecting the restraint control module from a vehicle body.

8. The method of claim 7, further comprising connecting a ground wire of the device to the restraint control module and to the vehicle body.

9. The method of claim 6, wherein the vehicle restraint device is communicatively connected to the device via the main body wire harness.

10. The method of claim 6, further comprising actuating, via a vehicle computer, an assist feature based on the data indicating the vehicle impact.

11. The method of claim 6, further comprising receiving, from a remote computer, the data indicating the vehicle impact.

12. The method of claim 6, wherein the data indicating the vehicle impact is simulated data.

13. The method of claim 6, wherein the vehicle restraint device is one of an airbag, a pretensioner, and a retractor.

14. The method of claim 6, further comprising preventing, via the device, actuation of the vehicle restraint device.

15. A system, comprising:
a vehicle computer including a first processor and a first memory, the first memory storing instructions executable by the first processor such that the vehicle computer is programmed to actuate an assist feature based on data indicating a vehicle impact;
a restraint control module;
a vehicle restraint device; and
a device communicatively connected to the restraint control module and communicatively connected, via a main body wire harness, to the vehicle restraint device, the device including:
a restraint simulator configured to simulate actuation of vehicle restraint devices based on the data indicating the vehicle impact.

16. The system of claim 15, wherein the data indicating the vehicle impact is simulated data.

17. The system of claim 15, wherein the device further includes a ground wire configured to connect to the restraint control module and to a vehicle body.

18. The system of claim 15, wherein the restraint simulator is further configured to prevent actuation of the vehicle restraint device.

19. The system of claim 15, wherein the vehicle restraint device is one of an airbag, a pretensioner, and a retractor.

20. The system of claim 15, wherein the restraint simulator is one of a computer or a resistor.
